(19) United States
(12) Patent Application Publication
(10) Pub. No.: US 2013/0193011 A1
(43) Pub. Date: Aug. 1, 2013

(54) STORAGE BOX FOR GRADUATION GOWN

(71) Applicants: Abby Scanlan, White Plains, NY (US); Jesse Alexander, Cos Cob, CT (US)

(72) Inventors: Abby Scanlan, White Plains, NY (US); Jesse Alexander, Cos Cob, CT (US)

(73) Assignee: GRADUATIONS SOLUTIONS, LP D/B/A GRADUATION SOURCE, Port Chester, NY (US)

(21) Appl. No.: 13/476,095

(22) Filed: May 21, 2012

Related U.S. Application Data
(60) Provisional application No. 61/593,044, filed on Jan. 31, 2012.

(51) Int. Cl. B65D 85/18; B31B 1/26; B31B 1/78; B31B 1/90

(52) U.S. Cl. 206/281; 206/299; 493/103; 493/162; 493/309

(57) ABSTRACT

A storage box for a garment such as a graduation gown or keepsake item or other item requiring safe and long-lasting storage is fabricated in one rectangular piece. The storage box in its expanded state may be shipped as a flat rectangular piece approximately 20-40 centimeters wide by 60 to 100 centimeters long. Triangular folding corners join first and second collapsible sides respectively to a binding panel and to an inner folding side panel. An outer folding side panel locks the triangular folding corners joining the respective collapsible side panels with the inner folding side panel to form an inner compartment for receiving a garment for storage. Magnets may be embedded in a magnetic closure panel and at least one folding side panel of corresponding size, shape and location to lock the storage box.

This application claims the benefit of priority to U.S. Provisional Patent Application Ser. No. 61/593,044 filed Jan. 31, 2011, of the same title and the same inventors, incorporated by reference herein as to its entire contents.

### FIELD OF THE INVENTION

The present invention generally relates to a storage box for a graduation gown (or similar garments) or a keepsake item or any other item that may be safely stored in the disclosed storage box and, more particularly, to such a storage box having collapsible side panels, the box being fabricated in one piece and closed by magnetic attraction.

### BACKGROUND

A graduation event entails the wearing of a special graduation gown, a tasseled cap and, once one graduates from college or receives a graduate degree, it is common for the gown to be worn in an adorned state with graduation accessories indicative of the status of the degree received. Many graduates choose to purchase and preserve their gowns. Moreover, high school teachers, college and university professors and the like wear their gowns more than once, for example, at each graduation ceremony that they attend. Consequently, there is a need for a special storage box for a graduation gown and its associated accessories that will preserve and protect its contents for an indefinite period of time.

Storage boxes are known in the art that may be purchased, for example, for purposes of a move from one location to another, for storage of paper documents, and the like. A banker box, for example, comprises a lid having inwardly folding sides such that a flap may fold over a side and lock tabs from other sides that have been folded inward. A banker box is typically constructed of durable cardboard and is intended to protect and preserve its contents. On the other hand, such a box would not be of a proper size, shape and construction for preserving a graduation gown as the gown would be susceptible to wrinkling and any accessories could be damaged after the gown and accessories are placed in the banker box, notwithstanding the care taken to fold and place the gown and accessories in the banker box. Moreover, many banker boxes and storage boxes used, for example, during a move, are complicated to assemble. Many users require a tutorial or refresher on how to assemble and use such a complicated box.

There are many gowns or robes that may require similar protection, preservation and the like. These may include but are not limited to robes worn by officers of a court, robes worn by the clergy, robes worn by others in religious ceremonies such as choir robes, alter boy robes and the like. Other robes and gowns may require protection and preservation in a storage box in a similar manner as a graduation gown. Moreover, there may be many keepsake items or other items that require safe and long-lasting storage.

Given the foregoing, what is needed is a storage box for a graduation gown and accessories or similar gowns or robes and accessories or any other item that may require safe and long-lasting storage that is designed to consider the particular contents to be protected and preserved, is durable, may contain a congratulatory message or verse and is easy to assemble while it may be packed in its unassembled state as a flat rectangular panel with no waste in volume when stacked on top of one another.

### SUMMARY

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

The present invention meets the above-identified needs by providing a detailed description of an exemplary storage box for a graduation gown or similar robe or gown, a keepsake item or any other item that may require safe storage in a storage box as described below. Preferably the box is fabricated in one flat rectangular piece, with no cut-outs at the corners. The box may have folded triangular shaped and folded corners for collapsible sides. The box in its collapsed state lies flat and may be stacked with other such boxes for shipment with no wasted space. In its expanded or assembled state, the box comprises a binding panel and inner and outer folding sides forming, when un-collapsed, an inner compartment and a pair of similarly shaped collapsible folding side members. The inner compartment is formed for receiving a graduation gown and accessories by raising the binding and the pair of folding collapsible sides from the collapsed state. As the binding, pair of folding collapsible sides and inner and outer folding panels arc raised, so are collapsible sides raised from inside the inner compartment outward to form outer box walls. Then, the outer of the inner and outer folding side members is folded over the inner of the folding side members locking the folding corner and side members together by means of one or more magnets mounted in apertures on the joined and pre-folded inner and outer folding side panels. In this manner, a box inner compartment is formed. When manufacturing the box, the apertures for receiving the magnets may be covered with paper or other coating to prevent the magnets from falling out of the apertures.

Joined to the binding is a top panel and a magnetic closure panel. When the top panel is closed over the inner compartment, one or more magnets are positioned to mate with similarly disposed magnets of the folded inner and outer folding side panels. Preferably, two magnets are mounted in each of the inner and outer folding side panels and the magnetic closure panel, three magnets of which (times two being six magnets total) adhere to each other when the box is closed forming a relatively tight seal.

In an embodiment, the present invention provides a top panel interior side which may include a special felicitation in printed form that may comprise one or more sentences that may be addressed to the graduate, the parents of the graduate, the professor or teacher, a choir member, member of the clergy and the like, thus, customizing the box to a particular graduation ceremony, religious ceremony or to a participant in either.

In an embodiment, a storage box for a graduation or similar gown and accessories or other items) requiring safe storage comprises a flat rectangular panel constructed of sturdy paper, cardboard, plastic or material wherein the folding corners, side panels and magnetic closure panels thereof are capable of being folded along predetermined crease lines. The magnetic closure magnets may comprise individual circular, rectangular or other shaped magnets which are substantially flat and capable of being embedded in the magnetic closure panel and inner and outer folding side panels of the inner compartment. A ribbon or cloth tab may be provided on the outer of the folding side panels to assist a user in forming and collapsing the inner compartment. The cloth tab is particularly useful for unlocking the magnetically sealed outer panel from the inner panel, thus allowing the box to resume its flat rectangular collapsed shape.

Further features and advantages of the present invention, as, well as the structure and assembly by a user of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1A is a collapsed bottom view of a pre-fabricated storage box 100 in its collapsed state, for example, for stacking and shipping purposes and for receiving a graduation gown or related apparel in an expanded and unfolded state useful for implementing the present invention as a storage container; FIG. 1B is a collapsed top view of a pre-fabricated storage box 100 in its collapsed state for receiving, when expanded and unfolded, a graduation gown or related apparel or other items) requiring safe storage showing collapsed sides, the folding corners for the binding and the folding corners for the folding sides useful for implementing the present invention wherein dashed lines represent folds of the depicted flat rectangular shaped box in its collapsed state and solid lines represent sides of the box panels.

FIG. 2 is a perspective view of the storage box 100, partially expanded and unfolded, illustrating the use of folding corners for collapsible sides and binding wherein, following the arrows, the sides are raised and unfolded to form an inner compartment for receiving apparel to be stored in the box according to an embodiment of the present invention.

FIG. 3 is a further perspective view showing further assembly illustrating the folding sides of the pair of folding sides having been raised and unfolded and, following the depicted arrow; showing how an outer folding side may fold down to lock the other folding side in place and so form the inner compartment of the box according to an embodiment of the present invention.

FIG. 4 is a further perspective view of the storage box 100, showing closure of the box top and magnetic closure panel such that all six depicted magnets are in line, three each stacked on and adhering to one another in a closed top mode.

FIG. 5 shows particular detail of the folding corner at the bottom center of FIG. 1B and 2 where a binding panel meets a folded side panel.

FIG. 6 shows particular detail of the folding corner at the top right of FIG. 1B and 2 in a perspective view looking at the inner compartment where an outer folding panel folds over a folding corner and locks the inner and outer folding corners together as seen in FIG. 3.

### DETAILED DESCRIPTION

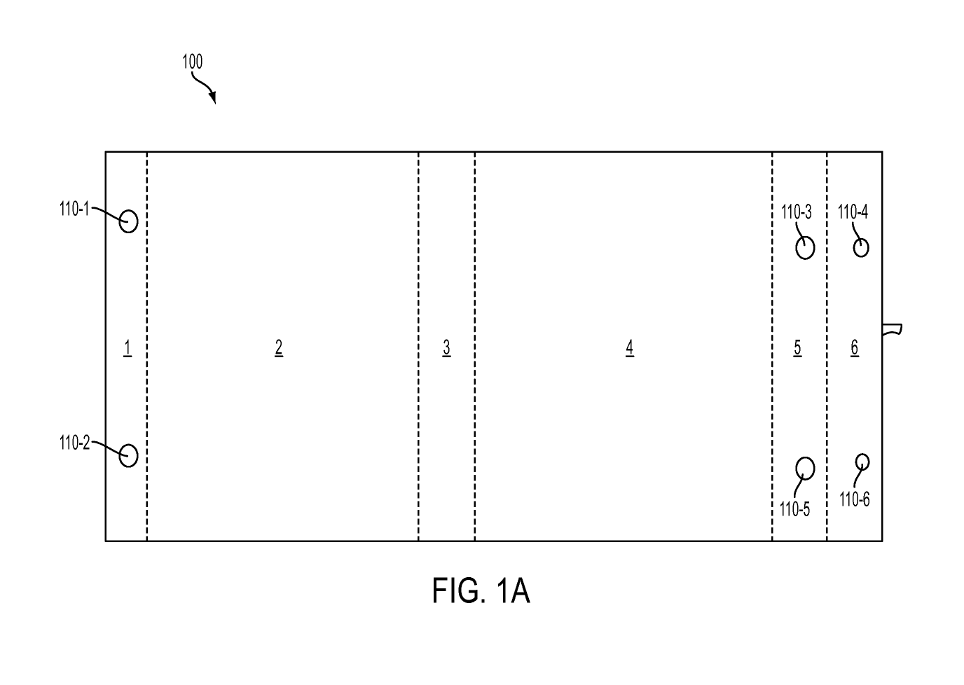

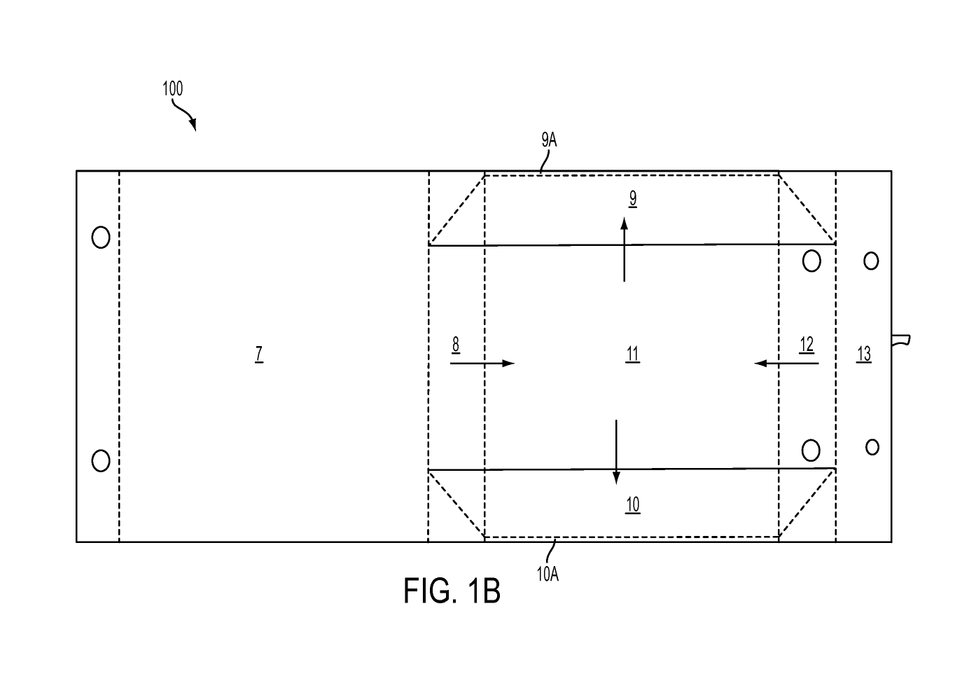

The present invention is directed to a storage box for a graduation gown and accessories or similar robe or gown such as may be used in graduation ceremonies, judicial proceedings and religious ceremonies by way of example or for any other item(s) such as keepsake items requiring safe and persistent storage. Reference will be made to FIGS. 1-6 for describing the storage box and its assembly and construction. Similar reference numerals will be used in the drawings to indicate similar elements.

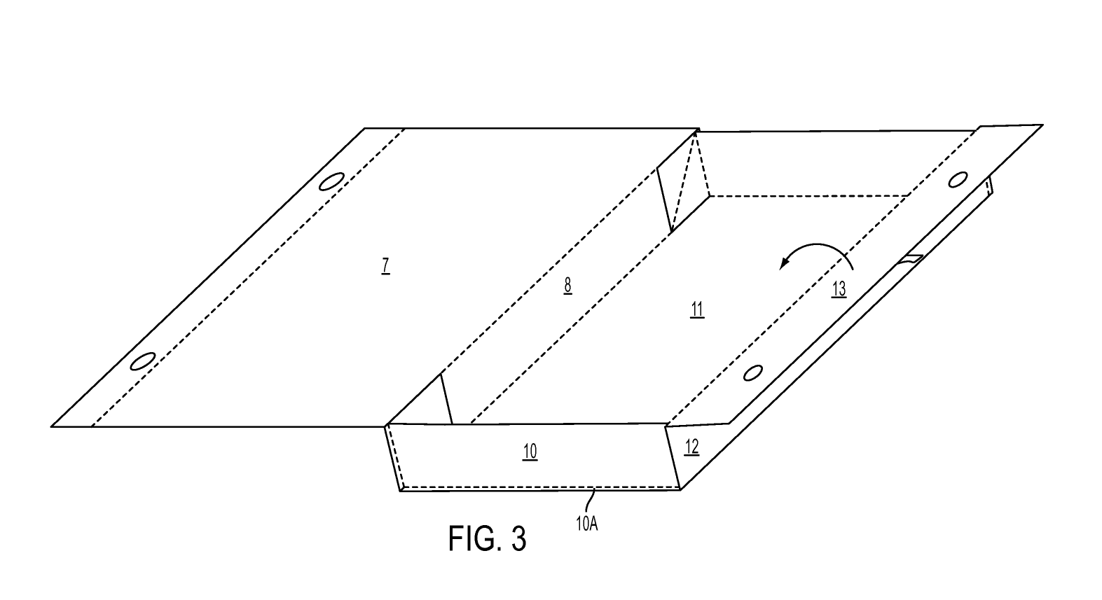

In an embodiment, with reference to FIGS. 1A and 1B, the present invention provides a flat rectangular storage box 100 in its collapsed or unfolded state where it may be stacked with other such boxes for shipment. FIG. 1A is a collapsed bottom view of the pre-fabricated storage box 100 in its collapsed state, for example, shaped as a flat rectangular panel suitable for stacking and shipping purposes without any cut-outs and no wasted volume. When unfolded and expanded, an inner compartment is formed for receiving a graduation gown or related apparel in an expanded and unfolded state. Dimensions provided or suggested herein are exemplary and may vary within a range of plus or minus twenty percent from the dimensions shown for teens and adults. (For example, a graduation gown for a child graduating from an elementary school may require a box for their gown that provides 50% of the volume). The collapsed flat top and bottom views of FIG. 1A and 1B indicate that the box may be of a rectangular shape with its folds shown in dashed line. A typical size may be 31.5 centimeters wide. The box 100 may be 6 cm (magnetic closure panel 1) plus 26 (lid 2, 7) plus 6 (binding panel 3, 8) plus 26 (bottom 4, 11) plus 5.75 (inner folding panel 5, 12) plus 5.75 (outer folding panel 6, 13) or, in total, 75.5 centimeters in length. When it is folded into its box shape and sealed close (see FIG. 3, but the box lid is not closed), the box is approximately 26 cm (W)×31.5 cm (L) by 6 centimeters (T). Stated in inches, the box 100 when closed may have exterior dimensions of width between 9 inches and 11 inches, length, 10 inches to 13 inches and thickness, one and ½ inches to 3 inches depending on the size of the gown or other garment to be stored in the box 100.

In an embodiment, referring still to FIG. 1A (outside view) and 1B (inside view), the storage box 100 of the present invention comprises from left to right in FIG. 1A (outside view), a magnetic closure panel 1, a top 2, a binding 3, a bottom 4, an inner folding side 5, a second or outer folding side 6 and an unlabeled paper tab or cloth pull, for example, preferably made of cloth connected to the approximate center of the outer folding side 6. From left to right in inside view FIG. 1B, box 100 comprises magnetic closure panel, top panel 7 (the other side of top 2), binding 8 (the other side of binding 3), inner compartment 11 (the other side of bottom 4), the inner compartment having collapsible sides 9, 10 with folding corners at each end, a first inner folding side 12 (the other side of folding side 5) and a second outer folding side 13 (the other side of folding side 6) and the folding ribbon, paper or cloth tab. The collapsible sides 9, 10 cannot be seen in the outside view of FIG. 1A. The sides 9, 10 become the outer walls of the inner compartment when the storage box 100 is in an expanded state or the box 100 unfolded following the arrows of FIG. 1B.

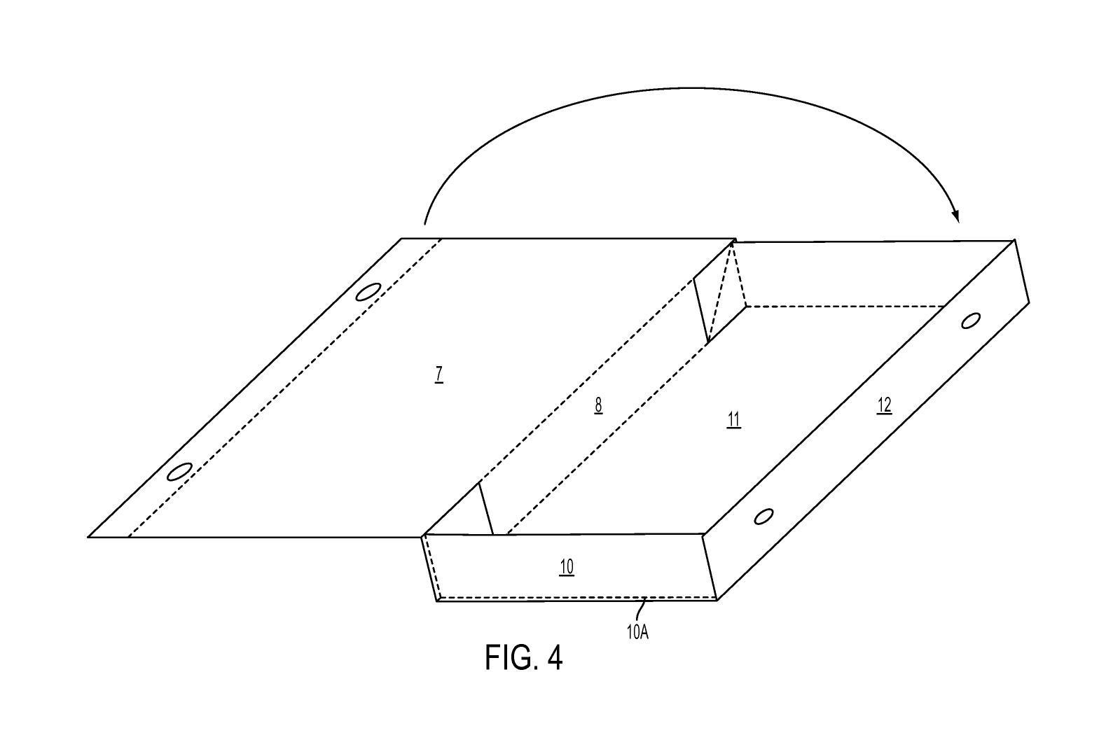

Arrows are shown in FIG. 1B showing a direction of folding of binding 8 and side 12 inward as collapsible sides 9 and 10 are raised to form a complete inner compartment 11 for receiving a gown and accessories. As the binding 8 and side 12 are folded inward according to the depicted arrows, collapsible sides 9 and 10 rise outward from a collapsed position folded inward over inner compartment 11 to form outer walls of the inner compartment 11. Once the folding is performed forming the complete inner compartment 11, raising the collapsible sides 9, 10, (arrows shown), folding side 6, 13 will be folded over and locks folding side 5, 12 to fully complete the inner compartment 11. At least three magnets are preferred for magnetically sealing the sides together. Magnets 110-1 through magnets 110-6 are shown embedded in magnetic closure 1 and folding sides 5, 6, 12, 13 so as to be covered with a relatively thin sheet of material compared with the thickness of the sides of the storage box 100. In a preferred embodiment, two sets of three magnets each are placed, for example, one third the width of the box in each panel in which they may be embedded. Because all magnets are disposed in similar locations on their respective sides, all magnets can attract one another and maintain the inner compartment closed to the magnetic closure side when the storage box 100 is closed (see steps of FIGS. 3 and 4 for forming the closed box 100).

Referring still to FIG. 1B, the collapsible sides 9, 10 need not be provided with a fold joining inner compartment 11 at the outer edges of the inner compartment 11. in one embodiment, there may be gaps 9A and 10A intentionally formed such that collapsible sides 9, 10 join inner compartment 11 at folds which are slightly recessed from the outer edges of inner compartment 11. As the box is fully formed per FIG. 4, the box 100 may appear to have recessed collapsible sides 9, 10 from the outer edges of the storage box 100 on all four sides of each collapsible side 9, 10. In this manner, the box creates an ornamental design. It appears to be almost in the shape of a book, (symbolic of a graduation or school) having slightly recessed collapsible sides 9, 10 by the width of gaps 9A, 10A. The recess may be, for example, minimal and on the order of two to four millimeters, by way of example along the lengths of gaps 9A, 10A parallel to the outer edges of inner compartment 11. A book is symbolic of graduation. The recesses (formed by gaps 9A, 10A) may be eliminated in alternative embodiments.

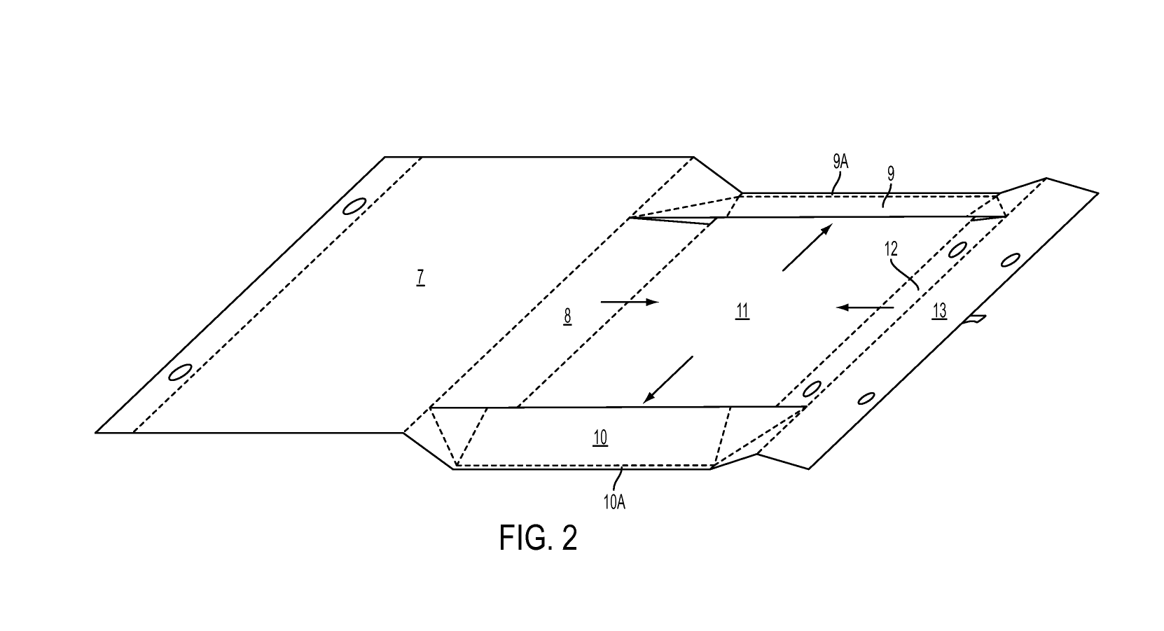

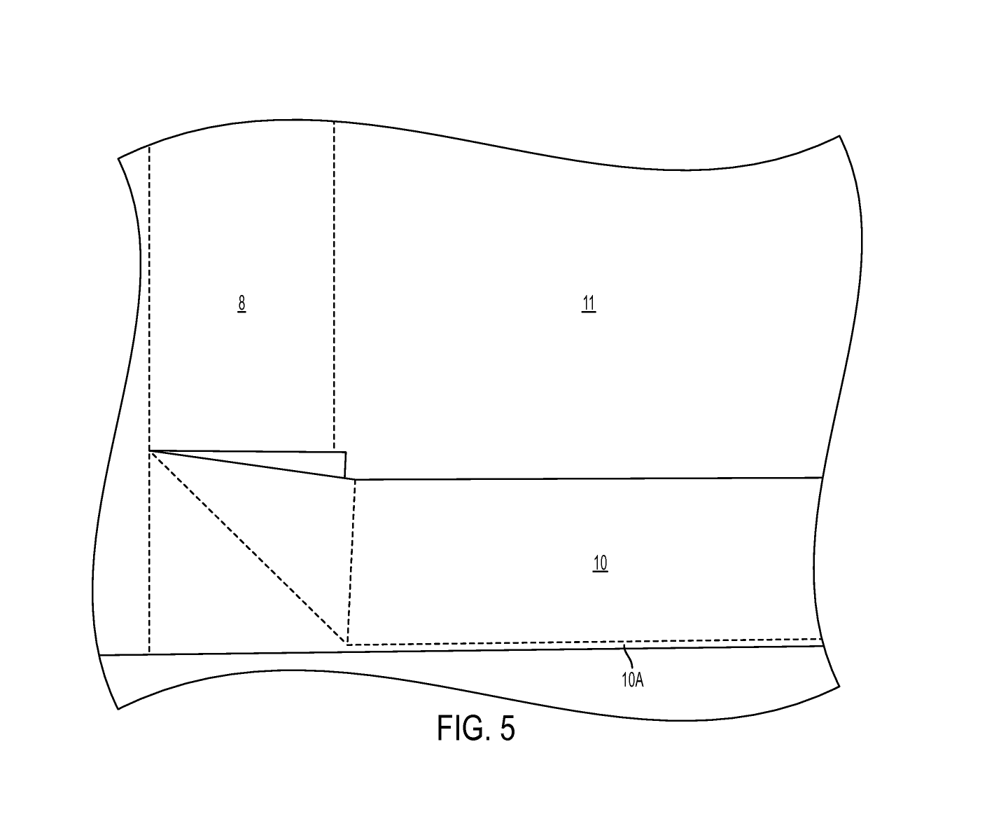

Referring now to FIG. 2, FIG. 2 is a perspective view illustrating opening folding corners for collapsible sides 9, 10 (collapsible side 10 shown) and binding 3, 8 (binding 8 shown) and a similar folding corner for a folding side 12 of a pair of inner and outer folding sides where inner folding side 12 joins collapsible sides 9, 10 according to an embodiment of the present invention. Following the arrows of FIG. 1B and 2, a user approximately simultaneously raises binding 3, 8 and folding sides 5, 6, 12, 13 so that collapsible sides 9; 10 rise to form outer walls of inner compartment 11 so that all the unfolded sides are at right angles to the plane of the bottom 11 of box 100. The folding corner itself is shown in greater detail in FIGS. 5 (and 6) as comprising a first triangular piece formed, for example, as a permanent attachment to (or in an alternative embodiment integrated with) binding 8. Another triangular piece is moveable and joins binding 8 and collapsible side 10 so that when binding 8 is raised, collapsible side 10 becomes an outer wall of the inner compartment 11. The perspective view of FIG. 2 shows binding 8 and inner front panel 12 in a partially raised state such that the collapsible sides 8, 10 have a vertical crease at the triangular folding corner to permit the collapsible sides 9, 10 to form side walls of the inner compartment 11. Also, referring to FIG. 2, gap 10A may be seen where collapsible side 10 joins inner compartment 8.

Referring quickly to FIG. 3, the folding corners have all been expanded. Both a fixed triangular portion of the folding corner and the moveable triangular portion where binding 8 meets side 9 (unlabeled) are seen in their raised states. Sides 9 and 10 are seen recessed the 2-4 mm width of for example, gap 10A.

FIG. 3 is a perspective view illustrating a next step in the assembly process. Similar folding corner for a folding side 5, 12 of the pair of folding sides 5,. 12, 6, 13 and showing, following the arced arrow, how one outer folding side 6, 13 may fold down to lock the other inner folding side 5, 12 in place by two pairs of magnets and so form an inner compartment 8, 10, 12/13, 9, 11 according to an embodiment of the present invention. The cloth tab attached to outer folding side 13 may be used to help close folding side 6, 13 or may be used to help unlock and open folding side 6, 13. The arced arrow of FIG. 3 shows how one folds down folding side 6, 13 into a locked position, locking the moveable, triangular corner in place to form and seal with magnets the inner compartment 11.

A felicitation or other printed matter may be provided on the interior of the top panel 7 as seen in FIG. 4. One such, message may be in the form of a poetic verse, hymn or other prose describing the event in which the enclosed garment or other item requiring safe storage is used: the joy of singing (choir garment), a biblical verse (religion) or a graduation congratulations (graduation) among other such felicitations, messages or verse. One such verse for a new graduate may comprise ten lines and read: “We know that time—extends beyond the ceremony, and so—do your student's accomplishments. —As your graduates age, saved in a box —of memories are their tassels; and—mounted on the walls of their—homes and office, their diplomas. —They become moments in time—that burn eternally in the hearts and minds—of students, family and faculty (the dashes indicate line breaks). This material may be protected by copyright. A similar verse or message may be presented inside the top panel 7 for a choir robe, a clergy gown, a professor or teacher's gown and the like. On the outside of the top panel, the source of the box may be depicted as Graduation Source in, for example, the color blue, and a slogan appear below in the color gold, “Achieving Made Simple.” Optionally, the same coloring and slogan may appear as trade dress on the sides and rear of the box with colored stripes surrounding and adorning the sides of the box. In one embodiment, the school colors may be used for the colored stripes and the school name may appear as the source of the box.

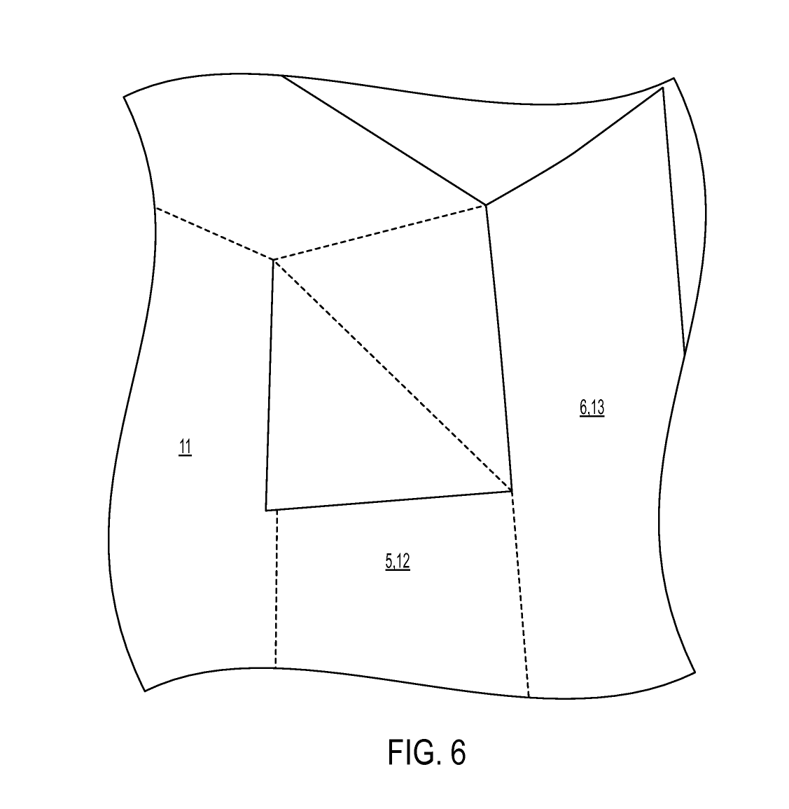

FIG. 5 has been described above and shows particular detail of the folding corner at the bottom center of FIG. 1B and 2 where a binding panel 8 (which raises) meets a folded side panel 10 (which is lifted outward). FIG. 6, on the other hand, shows particular detail of the folding corner at the top right of FIG. 1B and 2 in a perspective view looking at the inner compartment 11 floor where an outer folding panel 6, 13 folds over a folding corner and locks the outer folding corner to the inner folding corner of inner folding side panel 5, 12. These come together as seen in FIG. 3.

The several depicted sides may comprise, for example, cardboard, plastic, heavy board or other strong material and be coated with protective laminated paper or other coating material sufficient to hold the magnets 110 in their associated apertures. One side may be laminated and, then, the magnets 110 inserted in predetermined apertures at predetermined locations within the cardboard apertures. Once the magnets are in place, the other side may be laminated and seal the magnets 110 in their apertures. While circular magnets are shown of approximately two centimeters in diameter, other sizes and shapes of magnets may be used. Indeed, the magnet 110 may comprise a structural member of a magnetic closure or folding side, molded, for example, into plastic. On the other hand, it is important that the magnets be of similar size and shape and so match one another in location when the box is open to receive apparel or closed to form a locking relationship to one another when the storage box 100 is assembled and closed. Common magnetic materials may be used to form the magnets 110 such as Ceramic8 (ferrite), Alnico5 (cast), Alnico8 (cast), SmCo16, SmCo28, NdFeB31 and NdFeB44.

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects, but should be defined only in accordance with the following claims and their equivalents.

In addition, it should be understood that the figures in the attachments, which highlight the structure, methodology, functionality and advantages, of the present invention, are presented for example purposes only. The present invention is sufficiently flexible and configurable, such that it may be implemented in ways other than that shown in the accompanying figures.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A storage box for a garment or other item requiring safe storage, the storage box fabricated as a single flat rectangular piece of durable material having predetermined width and length, the single flat rectangular piece having a scalable aperture in a magnetic closure panel for receiving a magnet and at least one of an inner and an outer folding side thereof having a similar scalable aperture for receiving a similarly shaped magnet to the magnetic closure panel magnet at a location corresponding to a location of the scalable aperture of the magnetic closure panel, the storage box comprising in an expanded, unfolded, state,
the magnetic closure panel of the predetermined width including the magnet at a predetermined location of the sealable aperture;
a top panel of the predetermined width and having a length predetermined and corresponding to a size of the garment to be stored connected to the magnetic closure panel by a fold;
a binding panel of the predetermined width and having a predetermined length corresponding to a size of the garment to be stored, the binding panel connected to the top panel by a fold;
an inner compartment panel of the predetermined width and having a predetermined length corresponding to the length of the top panel and connected to the binding panel by a fold;
first and second inwardly collapsible side panels of approximately corresponding width to the, length of the binding panel and connected to the inner compartment panel by first and second corresponding, folds and to the binding panel by first and second corresponding triangular folding corners;
the inner folding side panel of the predetermined width and having a length approximately corresponding to the length of the binding panel, the inner folding side panel being connected to the inner compartment panel by a fold and to the first and second collapsible side panels by two triangular folding corners; and
the outer folding side panel of the predetermined width and having a length approximately corresponding to the length of the binding panel and that of the inner folding side panel and connected by a fold to the inner folding side panel such that by approximately raising the binding panel and inner compartment panels, an inner storage box compartment is formed, the outer folding side panel adapted to fold over and lock the triangular folding corners.

2. The storage box of claim 1 comprising a verse or prose printed matter on an inner side of the top panel.

3. The storage box of claim 1, comprising first and second circular magnets received in first and second circular apertures of at least one of the inner and outer folding side panels and the magnetic closure panel respectively such that the magnetic closure panel adheres by magnetic force to the folding side panels when the storage box is closed.

4. The storage box of claim 3, wherein the first and second circular magnets are placed in apertures of a given panel at approximately one third the length of each panel.

5. The storage box of claim 3 wherein the magnets arc covered by a thin sheet of material on either side of a panel forming a laminated protective cover to thick board or paper material or plastic of which the storage box is fabricated.

6. The storage box of claim 1 wherein the collapsible side panels are attached at respective folds with the inner compartment panel so as to form gaps of predetermined width between the outer sides of the inner compartment panel and the folds with the collapsible side panels such that when the box is closed, the box comprises recessed collapsible sides surrounded by the inner compartment panel, the binding panel, the top panel, the magnetic closure panel and the folded inner and outer folding side panels.

7. The storage box of claim 1 comprising six magnets, two in spaced sealed apertures of the magnetic closure panel, two in spaced sealed apertures of the inner folding side panel and two in spaced sealed apertures of the outer folding side panel.

8. The storage box of claim 1 having, when closed and magnetically sealed, exterior dimensions of width between 9 inches and 11 inches, length, 10 inches to 13 inches and thickness, one and ½ inches to 3 inches.

9. The storage box of claim 1 when closed having a stripe in one of trade dress and school colors surrounding the exterior of the sides of the box identifying the source of the box and the box further comprising a slogan on an exterior surface of the box.

10. The storage box of claim 1, the outer folding side panel having a tab attached to approximately the midpoint of the outer folding side panel on an outer side, the cloth tab being accessible for raising the outer folding side panel from a closed position to an open position, permitting the box to be restored to a flat, rectangular piece of durable material from a folded state.

11. A method of forming a storage box from a flat rectangular sheet having the dimensions of approximately 20 to 40 centimeters wide and 60 to 100 centimeters long, the storage box fabricated as a single flat rectangular piece of durable material having predetermined width and length and a having sealed aperture in a magnetic closure panel for receiving a magnet and at least one of an inner and an outer folding side panel thereof having a similar sealed aperture for receiving a similarly shaped magnet to the magnetic closure panel magnet at a location corresponding to a location of the sealed aperture of the magnetic closure panel, the method of forming the storage box comprising
raising a binding panel and first and second collapsible side panels connected to the binding panel and to the inner folding side panel by triangular folds to a position perpendicular to a plane of an inner compartment panel to which the binding panel and collapsible side panels are connected by means of folds,
folding the outer folding side panel over the inner folding side panel and the triangular folds so as to lock the outer folding side panel to the inner folding side panel by magnetic force in the perpendicular position.

12. A method of manufacturing a storage box to form a flat rectangular sheet having the dimensions of approximately 20 to 40 centimeters wide and 60 to 100 centimeters long, the storage box fabricated as a single flat rectangular piece of durable material having predetermined width and length, the method of manufacture comprising
creating a first width-wise fold between a magnetic closure panel and a top panel, creating a second width-wise fold between the top panel and a binding panel, creating a third width-wise fold between the binding panel and a bottom panel, creating a fourth width-wise fold between the bottom panel and an inner side panel, and creating a fifth width-wise fold between an inner side panel and an outer side panel,
forming an aperture for receiving a magnet in each of the magnetic closure panel, the inner side panel and the outer side panel, and
forming first and second collapsible side panels about triangular folds between the binding panel and inner side panel.

13. The method of manufacturing a storage box of claim 12 further comprising forming two apertures in each of the magnetic closure; panel, the inner, side panel and the outer side panel, inserting magnets in each aperture and laminating the magnetic closure panel, the inner side panel and the outer side panel to embed the magnets.

14. The method of manufacturing a storage box of claim 12, the first and second collapsible side panels each having first triangular folds connecting to the binding panel and second triangular folds connecting to the inner side panel.
